(19) United States
(12) Patent Application Publication
(10) Pub. No.: US 2026/0316653 A1
(43) Pub. Date: Oct. 15, 2026

(54) TILTING CARGO DECK SYSTEM

(71) Applicant: GM Global Technology Operations LLC, Detroit, MI (US)

(72) Inventor: Garrick C. Zack, Troy, MI (US)

(73) Assignee: GM Global Technology Operations LLC, Detroit, MI (US)

(21) Appl. No.: 19/174,676

(22) Filed: Apr. 9, 2025

(51) Int. Cl. B60P 1/34

(52) U.S. Cl. CPC B60P 1/34

(57) ABSTRACT

A load deck includes a base including a first segment and a second segment pivotable relative to one another. A tiltable deck is disposed at the base. A plurality of wheels is rotatably coupled to the base and configured to support the load deck at a surface. A lifting mechanism disposed between the base and the tiltable deck is configured to adjust the load deck between a lowered state, where the tiltable deck is disposed at a first height relative to the ground surface and the first segment and the second segment are at a first angle relative to one another, and a raised state, where the tiltable deck is disposed at a second height relative to the ground surface greater than the first height and the first segment and the second segment are at a second angle relative to one another less than the first angle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to cargo-hauling equipment and vehicles. More specifically, it addresses trailers and self-propelled vehicles used for loading, transporting, and unloading cargo.

When loading cargo, a trailer must often be manually positioned adjacent to the cargo. Equipment such as hoists, fork-lifts, winches, or human effort must be used to load the cargo onto the trailer and unload cargo from the trailer. A self-propelled vehicle must be coupled to the trailer to maneuver the trailer to the cargo or to a location at which the cargo is to be delivered. The trailer and/or vehicle may have limited means by which to orient the trailer for easier loading and unloading of the cargo. Therefore, there is a need for an improved apparatus for positioning the trailer and/or vehicle at the cargo or a destination for the cargo and for maneuvering the trailer about a worksite or between destinations.

### SUMMARY

In some aspects, a load deck includes a base including a first segment and a second segment, the first segment and the second segment are pivotable relative to one another. A tiltable deck is disposed at the base. A plurality of wheels are rotatably coupled to the base and configured to support the load deck at a ground surface. A lifting mechanism is disposed between the base and the tiltable deck. The lifting mechanism is configured to adjust the load deck between at least a lowered state and a raised state. In the lowered state, the tiltable deck is disposed at a first height relative to the ground surface and the first segment and the second segment are at a first angle relative to one another. In the raised state, the tiltable deck is disposed at a second height relative to the ground surface greater than the first height and the first segment and the second segment are at a second angle relative to one another less than the first angle.

In some examples, the lifting mechanism is configured to adjust the load deck to a tilted state, where a first end portion of the tiltable deck is disposed at a third height relative to the ground surface, a second end portion of the tiltable deck opposite the first end portion is disposed at a fourth height relative to the ground surface greater than the third height, and the first segment and the second segment are at a third angle relative to one another between the first angle and the second angle. In some configurations, the base includes a third segment. The first segment of the base is pivotably coupled to the third segment of the base, and the second segment of the base is pivotably coupled to the third segment of the base. Additionally or alternatively, the lifting mechanism may include a plurality of lifting mechanisms. Optionally, a first lifting mechanism of the plurality of lifting mechanisms is coupled to the first segment of the base and a second lifting mechanism of the plurality of lifting mechanisms is coupled to the second segment of the base.

In other examples, the lifting mechanism is configured to expand between the tiltable deck and the base to adjust the load deck from the lowered state toward the raised state, and the lifting mechanism is configured to contract between the tiltable deck and the base to adjust the load deck from the raised state toward the lowered state. In some configurations, the lifting mechanism includes at least one selected from the group consisting of an inflatable bladder, a hydraulic piston, and an electromechanical jack. In further examples, the tiltable deck includes a top deck slidably coupled to a subdeck. Additionally or alternatively, the plurality of wheels may include a first pair of wheels disposed at the first segment and a second pair of wheels disposed at the second segment. The first pair of wheels and the second pair of wheels move toward one another along the ground surface as the load deck is adjusted from the lowered state to the raised state. Optionally, the first pair of wheels is slidably coupled to the first segment and the second pair of wheels is slidably coupled to the second segment.

In other aspects, a trailer includes a base including a first segment and a second segment. The first segment and the second segment are pivotable relative to one another. A tiltable deck is disposed at the base. A reinforcement plate is coupled to the tiltable deck, the first segment, and the second segment. A plurality of wheels is rotatably coupled to the base and configured to support the trailer at a ground surface. A hitch connector is coupled to the base and configured to connect the trailer to a vehicle. A lifting mechanism is disposed between the base and the tiltable deck, the lifting mechanism configured to adjust the trailer between at least a lowered state and a raised state. In the lowered state, the tiltable deck is disposed at a first height relative to the ground surface and the first segment and the second segment are at a first angle relative to one another. In the raised state, the tiltable deck is disposed at a second height relative to the ground surface greater than the first height and the first segment and the second segment are at a second angle relative to one another less than the first angle.

In some examples, the lifting mechanism is configured to adjust the trailer to a tilted state, where a first end portion of the tiltable deck is disposed at a third height relative to the ground surface, a second end portion of the tiltable deck opposite the first end portion is disposed at a fourth height relative to the ground surface greater than the third height, and the first segment and the second segment are at a third angle relative to one another between the first angle and the second angle. In some configurations, the base includes a third segment. The first segment of the base is pivotably coupled to the third segment of the base, and the second segment of the base is pivotably coupled to the third segment of the base. Additionally or alternatively, the lifting mechanism may include a plurality of lifting mechanisms. Optionally, a first lifting mechanism of the plurality of lifting mechanisms is coupled to the first segment of the base and a second lifting mechanism of the plurality of lifting mechanisms is coupled to the second segment of the base.

In other examples, the lifting mechanism includes at least one selected from the group consisting of an inflatable bladder, a hydraulic piston, and an electromechanical jack. In some configurations, the tiltable deck includes a top deck slidably coupled to a subdeck. In further examples, the plurality of wheels includes a first pair of wheels disposed at the first segment and a second pair of wheels disposed at the second segment. The first pair of wheels and the second pair of wheels move toward one another along the ground surface as the trailer is adjusted from the lowered state to the raised state. Additionally or alternatively, the trailer may further include a locking mechanism, the locking mechanism configured to releasably fix the tiltable deck to the base.

In further aspects, a vehicle includes a base including a first segment and a second segment. The first segment and the second segment are pivotable relative to one another. A tiltable deck is disposed at the base and includes a top deck slidably coupled to a subdeck. A plurality of wheels rotatably are coupled to the base and configured to support the vehicle at a ground surface. A propulsion system is configured to drive the plurality of wheels to move the vehicle along the ground surface. A first lifting mechanism is disposed between the first segment and the tiltable deck. A second lifting mechanism is disposed between the second segment and the tiltable deck. The first lifting mechanism and the second lifting mechanism are configured to adjust the vehicle between at least a lowered state, a raised state, and a tilted state. In the lowered state, the tiltable deck is disposed at a first height relative to the ground surface and the first segment and the second segment are at a first angle relative to one another. In the raised state, the tiltable deck is disposed at a second height relative to the ground surface greater than the first height and the first segment and the second segment are at a second angle relative to one another less than the first angle. In the tilted state, a first end portion of the tiltable deck is disposed at a third height relative to the ground surface, a second end portion of the tiltable deck opposite the first end portion is disposed at a fourth height relative to the ground surface greater than the third height, and the first segment and the second segment are at a third angle relative to one another between the first angle and the second angle.

### BRIEF DESCRIPTION OF THE DRAWINGS

The drawings described herein are for illustrative purposes only of selected configurations and are not intended to limit the scope of the present disclosure.

FIG. 1 is a side view of a load deck including a base having two segments according to the present disclosure, with the load deck in a tilted state;

FIG. 2 is a perspective view of a load deck including a base having three segments according to the present disclosure, with the load deck in a lowered state;

FIG. 3 is a side view of the load deck of FIG. 2, with the load deck in a raised state;

FIG. 4 is a perspective view of the load deck of FIG. 2, with the load deck in a tilted state and with a top deck slidably extended from the load deck;

FIG. 5 is a block diagram illustrating aspects of the load deck of FIG. 2;

FIG. 6 is a perspective view of the load deck of FIG. 2, with the load deck in the raised state and positioned adjacent a tow vehicle; and

FIG. 7 is a perspective view of the load deck of FIG. 2, with the load deck in the tilted state and with the top deck slidably extended from the load deck to receive cargo.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

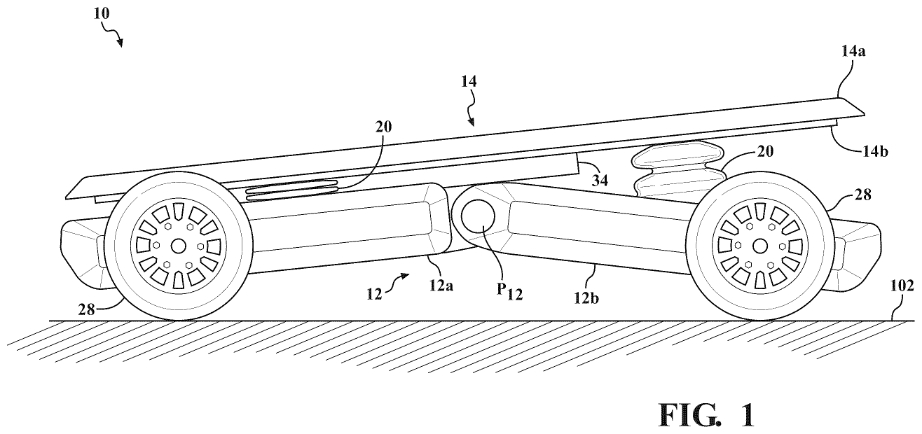

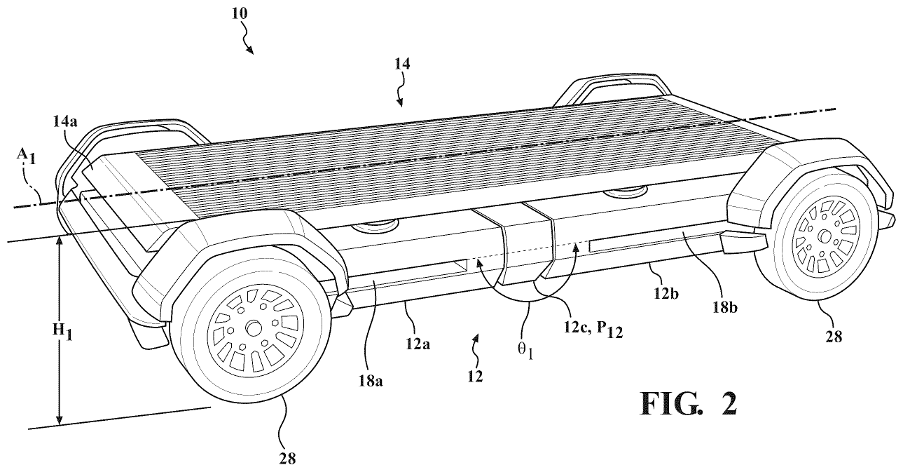

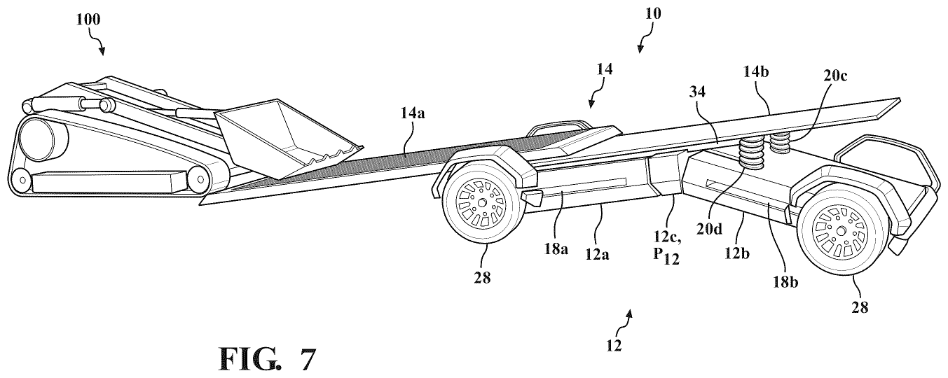

Referring to FIGS. 1-7, a load deck 10 includes a base 12 and a tiltable deck 14 to assist in loading and unloading of cargo 100. The base 12 includes a plurality of segments that pivot relative to one another to raise, lower, and/or tilt the tiltable deck 14 relative to a ground surface 102 and the base 12 may include any suitable number of segments. In the illustrated example of FIG. 1, the base 12 includes a first segment 12a pivotably coupled to a second segment 12b and in the illustrated example of FIGS. 2-7, the base 12 includes a third segment 12c disposed between the first segment 12a and the second segment 12b.

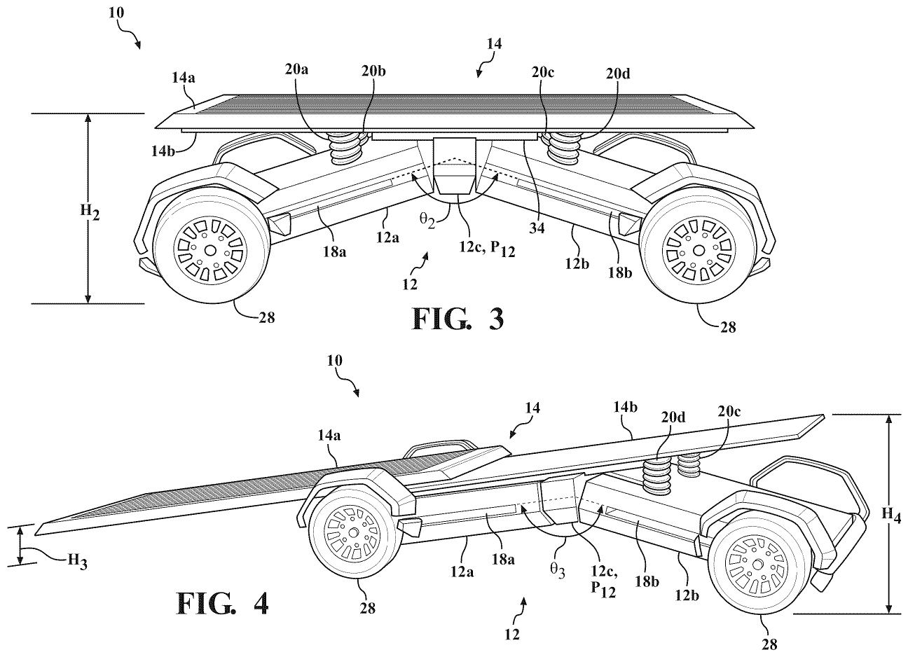

The tiltable deck 14 is disposed at the base 12 and includes a top deck 14a slidably coupled to a subdeck 14b. A lifting mechanism 20 is disposed between the base 12 and the tiltable deck 14. The lifting mechanism 20 adjusts the load deck 10 among a plurality of states 22, such as a lowered state 22a (FIG. 2), a raised state 22b (FIG. 3), and a tilted state 22c (FIG. 1). As discussed further below, in the various states 22, the tiltable deck 14 is disposed at various heights and/or angles relative to the ground 102, and the first segment 12a and the second segment 12b of the base 12 are at various angles relative to one another. Accordingly, actuating the lifting mechanism 20 articulates various aspects of the load deck 10. That is, the lifting mechanism 20 may extend and retract between the tiltable deck 14 and the segments of the base 12 to cause the first segment 12a and the second segment 12b to pivot or tilt relative to one another and thus raise or lower or angle the tiltable deck 14 relative to the ground surface 102. Thus, a user may adjust the load deck 10 to a desired height or angle for loading or unloading cargo at the tiltable deck 14.

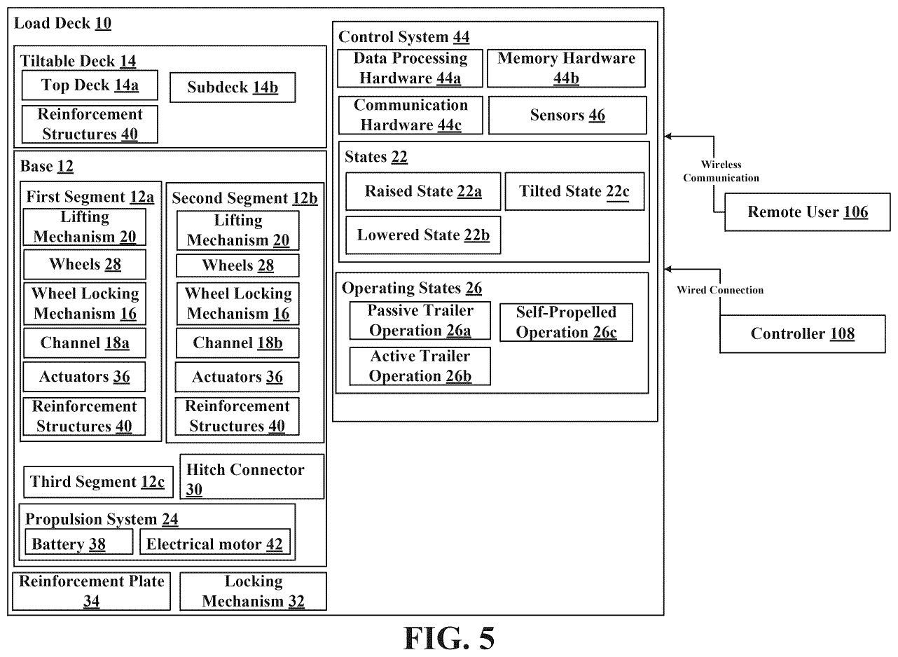

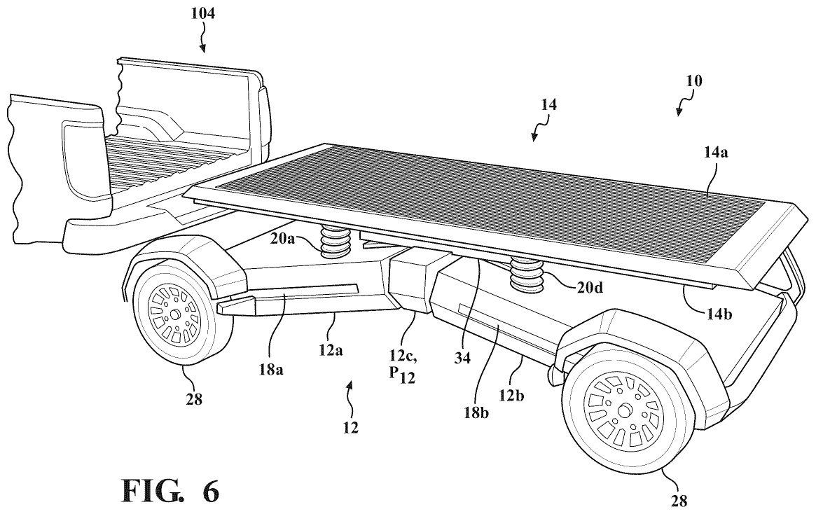

In some examples, the load deck 10 may act as an unpowered or non-propelled or passive trailer that may be removably coupled to a tow vehicle 104 to transport cargo 100 (FIG. 6). In other examples, the load deck 10 may act as a vehicle, self-propelled via a propulsion system 24 (e.g., an electric propulsion system) (FIG. 5). The load deck 10 may selectively transition among operating states 26, including a passive trailer operating state 26a, an active trailer operating state 26b, and a self-propelled operating state 26c.

As shown in FIG. 1, the base 12 includes a first segment 12a pivotably coupled to a second segment 12b at a substantially central location along a longitudinal axis A₁ of the base 12. Accordingly, the coupling of the first segment 12a to the second segment 12b defines a pivot-point P₁₂ about which the first segment 12a and the second segment 12b may rotate. As depicted in FIGS. 2-4, in some examples, the third segment 12c is substantially centrally located along the longitudinal axis A₁ of the base 12 between the first segment 12a and the second segment 12b. The first segment 12a is pivotably coupled to the third segment 12c, and the second segment 12b is pivotably coupled to the third segment 12c. Accordingly, the third segment 12c couples the first segment 12a to the second segment 12b and defines the pivot-point P₁₂ about which the first segment 12a and the second segment 12b may rotate. The pivotal coupling of the first segment 12a to the second segment 12b (either directly or via the third segment 12c) increases the potential range of tilt-angles of the tiltable deck 14, as discussed further below.

A plurality of wheels 28 rotatably coupled to the base 12 support the load deck 10 at a ground surface 102. In some examples, a first pair of wheels 28 are disposed at the first segment 12a, and a second pair of wheels 28 are disposed at the second segment 12b. The first pair of wheels 28 may be slidably coupled to the first segment 12a and the second pair of wheels 28 may be slidably coupled to the second segment 12b, such that the load deck 10 has an adjustable wheelbase. That is, the first pair of wheels 28 may slide or move along the longitudinal axis A₁ of the base 12 and ride along a channel 18a of the first segment 12a, and the second pair of wheels 28 may slide or move along the longitudinal axis A₁ of the base 12 and ride along a channel 18b of the second segment 12b. For example, the first pair of wheels 28 and the second pair of wheels 28 may slide toward one another, reducing the wheelbase of the load deck 10, or the first pair of wheels 28 and the second pair of wheels 28 may slide away from one another, extending the wheelbase of the load deck 10. Reducing the wheelbase may decrease the turn radius of the load deck 10, which increases maneuverability of the load deck 10, particularly when the load deck 10 acts as a passive trailer 26a. Increasing the wheelbase may increase the stability of the load deck 10, such that the load deck 10 may accommodate uneven weight distributions of cargo 100 along the tiltable deck 14. In some embodiments, a first wheel locking mechanism 16 may selectively fix the first pair of wheels 28 at a location along the first segment 12a to prevent the first pair of wheels 28 from sliding about the first segment 12a. A second wheel locking mechanism 16 may selectively fix the second pair of wheels 28 at a location along the second segment 12b to prevent the pair of wheels 28 from sliding about the second segment 12b.

Optionally, the load deck 10 may include additional wheels 28 to increase stability of the load deck 10 or increase the payload of the load deck 10 (i.e., increase the weight capacity of cargo 100 that the load deck 10 can support). For example, the load deck 10 may be equipped with six (6) wheels or eight (8) wheels for heavy-payload applications. In some embodiments, a hitch connector 30 may be coupled to the base 12 at the first segment 12a and/or the second segment 12b. The hitch connector 30 is configured to connect the load deck 10 to a tow vehicle 104 when the load deck 10 is in a state of passive trailer operation 26a.

The tiltable deck 14 is disposed at the base 12 and includes a top deck 14a and a subdeck 14b. The top deck 14a is slidably coupled to the subdeck 14b, such that the top deck 14a may extend outwardly from the subdeck 14b, as illustrated in FIG. 4. For example, the tiltable deck 14 may include tracks or rollers along which the top deck 14a slides with respect to the subdeck 14b. In some examples, a locking mechanism 32 may be configured to releasably fix the tiltable deck 14 to the base 12. The locking mechanism 32 may prevent relative motion between the tiltable deck 14 and the base 12.

Optionally, a reinforcement plate 34 may be disposed between the tiltable deck 14 and the base 12 at the pivot-point P₁₂ about which the first segment 12a and the second segment 12b rotate. The reinforcing plate 34 prevents bending or deflection of the tiltable deck 14 when the tiltable deck 14 is raised from the base 12 or pivots about the base 12, as discussed further below. In one example, the reinforcement plate 34 may be coupled to the tiltable deck 14 at the subdeck 14b, the first segment 12a, and the second segment 12b. In another example, the reinforcement plate 34 may be coupled to the tiltable deck 14 at the subdeck 14b and the third segment 12c. The reinforcement plate 34 may be steel, titanium, an alloy of metals, or a composite material, such that the reinforcement plate 34 increases the rigidity of the tiltable deck 14.

The top deck 14a may be aluminum, steel, titanium, an alloy of metals, or a composite material. In some examples, the material of the top deck 14a may be selected to reduce the weight of the tiltable deck 14, increasing maneuverability and reducing stress on the subdeck 14b and components of the load deck 10 caused by tilting the tiltable deck 14 or extending the top deck 14a outwardly from the subdeck 14b. In other examples, the material of the top deck 14a may be selected to increase strength of the top deck 14a, thus increasing the weight capacity of the load deck 10. In another aspect, the top deck 14a may be a solid plate to maximize weight capacity of the load deck 10, or the top deck 14a may be a frame to reduce the weight of the load deck 10.

The subdeck 14b may be aluminum, steel, titanium, an alloy of metals, or a composite material. In some examples, the material of the subdeck 14b may be selected to reduce the weight of the tiltable deck 14. In other examples, the material of the subdeck 14b may be selected to increase strength of the subdeck 14b, thus increasing the weight capacity of the load deck 10. In another aspect, the subdeck 14b may be a solid plate to maximize weight capacity of the load deck 10, or the top deck 14a may be a frame to reduce the weight of the load deck 10.

Lifting mechanism 20 is disposed between the base 12 and the tiltable deck 14. In some examples, the lifting mechanism 20 includes a plurality of lifting mechanisms 20, such as four or more lifting mechanisms 20 that operate individually or in cooperation to adjust the tiltable deck 14 and the base 12. The lifting mechanisms 20 raise and lower the tiltable deck 14 in various orientations by expanding and/or contracting between the tiltable deck 14 and the base 12. The lifting mechanisms 20 may collectively expand to raise the tiltable deck 14 upwardly from the base 12 while keeping the tiltable deck 14 substantially level or parallel to the ground 102. The lifting mechanisms 20 may collectively contract to lower the tiltable deck 14 such that the tiltable deck 14 is located just above the base 12 or is resting on the base 12. Thus, the tiltable deck 14 may be disposed at a first height HI relative to the ground surface 102 in the lowered state 22a and at a second height H₂ relative to the ground surface 102 in the raised state 22b, where the second height H₂ is greater than the first height H_{1.}

As the tiltable deck 14 raises relative to the ground surface 102, the base 12 may fold or pivot to accommodate movement of the tiltable deck 14. For example, in the lowered state 22a the first segment 12a and the second segment 12b may be disposed at a first angle θ₁ relative to one another (e.g., substantially parallel to one another). As the tiltable deck 14 lifts, the third segment 12c attached to the tiltable deck 14 raises with the tiltable deck 14, causing the first segment 12a and the second segment 12b to pivot relative to the third segment 12c as the wheels 28 remain on the ground surface 102. Thus, in the raised state 22b, the first segment 12a and the second segment 12b are at a second angle θ₂ relative to one another that is non-parallel and smaller than the first angle θ₁. The wheels 28 may move along the ground surface 102 to accommodate expansion and contraction of the base 12 as the segments pivot relative to one another.

Moreover, in the tilted state 22c, one side of the tiltable deck 14 may raise to a greater degree than the other side of the tiltable deck 14. In the illustrated example of FIG. 4, the portion of the tiltable deck 14 coupled to the second segment 12b is raised relative to the base 12 while the portion of the tiltable deck 14 coupled to the first segment 12a is not raised relative to the base 12. Thus, the second segment 12b is pivoted relative to the third segment 12c and the first segment 12a is not pivoted relative to the third segment 12c such that first segment 12a and the second segment 12b are at a third angle θ₃ relative to one another between the first angle θ₁ and the second angle θ₂. This may result in a first end of the tiltable deck 14 being disposed at a third height H₃ relative to the ground surface 102 and a second end of the tiltable deck 14 being disposed at a fourth height H₄ relative to the ground surface 102 that is greater than the third height H_{3.}

The lifting mechanisms 20 may selectively expand and contract to maintain the tiltable deck 14 in a level orientation while the load deck 10 transports cargo 100. For example, the lifting mechanisms 20 may selectively expand and contract to maintain the tiltable deck 14 in a level orientation as the load deck 10 traverses uneven terrain.

The plurality of lifting mechanisms 20 may be distributed among various locations about the load deck 10. In the illustrated example of FIG. 3, a first lifting mechanism 20a and a second lifting mechanism 20b may be coupled to the first segment 12a of the base 12 and a third lifting mechanism 20c and a fourth lifting mechanism 20d may be coupled to the second segment 12b of the base 12. Lifting mechanisms 20 coupled to one segment may expand while other lifting mechanisms 20 coupled to the other segment may remain stationary or contract, tilting the tiltable deck 14 such that a first portion of the tiltable deck 14 is higher relative to the ground 102 than a second portion of the tiltable deck 14. For example, a lifting mechanism 20 disposed between the tiltable deck 14 and the first segment 12a may contract and a lifting mechanism 20 disposed between the tiltable deck 14 and the second segment 12b may expand, such that the tiltable deck 14 tilts downwardly toward the first segment 12a, as illustrated in FIGS. 1 and 4.

In some embodiments, a plurality of lifting mechanisms 20 may be coupled to each of the first segment 12a and the second segment 12b. For example, two (2) lifting mechanisms, four (4) lifting mechanisms, six (6) lifting mechanisms, or eight (8) lifting mechanisms may be coupled to each of the first segment 12a and the second segment 12b. The lifting mechanisms 20 may be distributed at each corner of the base 12 and the tiltable deck 14 to maximize stability of the tiltable deck 14 and maximize control of the orientation of the tiltable deck 14. Locating the lifting mechanisms 20 proximate to the ends of the base 12 and tiltable deck 14 may increase torque that the lifting mechanisms 20 can exert on the tiltable deck 14 and increase stability of the tiltable deck 14. Locating the lifting mechanisms 20 toward the pivot-point P₁₂ defined between the first segment 12a and the second segment 12b may reduce the required length of travel of the lifting mechanisms 20 and increase the range of motion of the first segment 12a and the second segment 12b of the base 12. The lifting mechanisms 20 may also be disposed about the load deck 10 in locations so as to meet various operating requirements, such as minimizing stress on the base 12 and/or the tiltable deck 14 or maximizing payload of the load deck 10. In some examples, one or more lifting mechanisms 20 may be disposed at the third segment 12c. The lifting mechanism 20 disposed at the third segment 12c may increase payload of the load deck 10 and/or improve weight distribution among the lifting mechanisms 20.

The lifting mechanism 20 may include an inflatable bladder, a hydraulic piston, an electromechanical jack, or any combination of these. Actuators 36 for the lifting mechanism 20 such as air compressors, hydraulic pumps, electrical motors, and accompanying components may be disposed at either of the base 12. The actuators 36 may be powered by a battery 38 disposed at the base 12. Additionally or alternatively, the actuators 36 may be powered by a power source disposed at the tow vehicle 104 vie an electrical, hydraulic, or mechanical connection between the tow vehicle 104 and the load deck 10. The base 12 and the tiltable deck 14 may each include reinforcement structures 40 disposed at each lifting mechanism 20 in order to prevent damage to the base 12 and the tiltable deck 14 under load and increase the weight capacity of the load deck 10. The reinforcement structures 40 may include metal plates, metal frames, or other reinforced mounting points.

In some embodiments, the plurality of wheels 28 rotatably coupled to the base 12 may be driven by an electric propulsion system 24. The propulsion system 24 includes the battery 38 electrically coupled to one or more electrical motors 42 disposed at the base 12. The one or more motors 42 may selectively rotate one or more of the wheels 28. The load deck 10 may selectively operate in a passive trailer operating state 26a, an active trailer operating state 26b, or a self-propelled operating state 26c. For example, when hitched to a tow vehicle 104, the load deck 10 may operate in the passive trailer operating state 26a when tow vehicle 104 is towing the load deck 10 above a threshold speed. For example, the threshold speed may be fifteen (15) miles per hour (MPH), twenty (20) MPH, forty (40) MPH, or fifty (50) MPH. By operating in a passive trailer state 26a while the tow vehicle 104 is traveling at high speed, the load deck 10 preserves the battery 38 and reduces wear on components of the propulsion system 24.

The load deck 10 may operate in an active trailer operating state 26b when the tow vehicle 104 is towing the load deck 10 below the threshold speed. By operating in the active trailer state 26b below the threshold speed, the load deck 10 may reduce energy consumption of the tow vehicle 104 and help the tow vehicle 104 accelerate, decelerate, and maintain traction when traversing slippery or uneven terrain. The load deck 10 may also regenerate electrical power during deceleration while in the active trailer state 26b. Optionally, a user 106 of the load deck 10 may selectively disable the active trailer state 26b when propulsion is not desired.

The load deck 10 may further operate in a self-propelled state 26c when the load deck 10 is not coupled to a tow vehicle 104. That is, the load deck 10 may operate as a self-propelled vehicle. The wheels 28 of the load deck 10 may articulate about a mounting point, acting as a steering system for the load deck 10 when the load deck 10 operates in the self-propelled state 26c. The load deck 10 may operate autonomously in the self-propelled state 26c.

The load deck 10 may include a control system 44 that controls operation of the load deck 10, including acceleration, deceleration, speed, and steering, of the load deck 10 and control operation of the tiltable deck 14. The control system 44 receives instructions from a user 106 to perform operations of the load deck 10. In some examples, the control system 44 may receive instructions communicated by the user 106 wirelessly, such as via Bluetooth, Wi-Fi, radio, satellite, or other wireless connection. In other examples, the control system 44 may receive instructions communicated via a wired connection, such as with a tow vehicle 104 or a wired controller 108. The control system 44 may further receive input signals via sensors 46 disposed at the load deck 10, such as one or more of cameras, radars, lidars, ultrasonic sensors, or other sensors for detecting information regarding the environment surrounding the load deck 10.

The control system 44 may control operation of the load deck 10 responsive to the instructions provided by the user 106 and/or sensor data, including avoiding objects, bystanders, or hazards surrounding the load deck 10, navigating to cargo 100 selected by the user 106, and operating the tiltable deck 14 to load and unload the cargo 100. The control system 44 may operate the load deck 10 to assist the user 106 in coupling or decoupling the load deck 10 with a tow vehicle 104. The control system 44 includes data processing hardware 44a, memory hardware 44b, the memory hardware 44b storing instructions that when executed on the data processing hardware 44a cause the data processing hardware 44a to perform operations of the load deck 10. The memory hardware 44b also stores instructions for communication via the communication hardware 44c.

In operation, the load deck 10 may adjust the orientation of the base 12 and/or the tiltable deck 14 in order to assist in loading, unloading, and transporting cargo 100. The load deck 10 may adjust the height and angle of the tiltable deck 14, extend or retract the top deck 14a, and/or adjust the angle of the first segment 12a and the second segment 12b of the base 12. The lifting mechanisms 20 may lower the tiltable deck 14 or raise the tiltable deck 14 while maintaining the tiltable deck 14 substantially parallel to the ground 102. For example, the lifting mechanisms 20 may raise the tiltable deck 14 to the height of a raised platform to assist in the loading or unloading of cargo 100. The lifting mechanisms 20 may lower the tiltable deck 14 such that the tiltable deck 14 is located just above the base 12 or is resting on the base 12 in order to maximize stability and aerodynamics of the load deck 10 while in transit between destinations. The load deck 10 may tilt the tiltable deck 14 by selectively expanding a first lifting mechanism 20 disposed at the first segment 12a of the base 12 and contracting a second lifting mechanism 20 disposed at the second segment 12b of the base 12. Force acting on the first segment 12a and the second segment 12b from the expansion and contraction of the lifting mechanisms 20 may also cause the first segment 12a and the second segment 12b to rotate about the pivot-point P_{12.}

The load deck 10 may change the angle of the first segment 12a and the second segment 12b of the base 12 to further raise, lower, or tilt the tiltable deck 14. The propulsion system 24 may rotate the first pair of wheels 28 disposed at the first segment 12a away from the second segment 12b and rotate the second pair of wheels 28 disposed at the second segment 12b away from the first segment 12a, such that the first segment 12a and the second segment 12b are at a first angle relative to one another. The first angle may be large, such that the base 12 is substantially flat and the first segment 12a and the second segment 12b form one plane, as illustrated in FIG. 2. Alternatively, the propulsion system 24 may rotate the first pair of wheels 28 disposed at the first segment 12a toward the second segment 12b, and rotate the second pair of wheels 28 disposed at the second segment 12b toward the first segment 12a, such that the first segment 12a and the second segment 12b are at a second angle relative to one another that is less than the first angle, as illustrated in FIG. 3. Accordingly, the pivot-point P₁₂ between the first segment 12a and the second segment 12b raises upwardly from the ground 102. The pivot-point P₁₂ may act as an axis about which the tiltable deck 14 tilts, as illustrated in FIG. 1.

The lifting mechanisms 20 and/or the propulsion system 24 may adjust the load deck 10 among various states 22a-22c by adjusting both the base 12 and the tiltable deck 14 for easier loading, transporting, and unloading of cargo 100. In the lowered state 22a, the tiltable deck 14 is disposed at a first height H₁ relative to the ground 102 and the first segment 12a and the second segment 12b of the base 12 are at a first angle θ₁ relative to one another. The first angle θ₁ may be large, such that the base 12 is substantially flat and the first segment 12a and the second segment 12b form one plane. In the raised state 22b, the tiltable deck 14 is disposed at a second height H₂ relative to the ground 102 greater than the first height H₁, and the first segment 12a and the second segment 12b of the base 12 are at a second angle θ₂ relative to one another, where the second angle θ₂ is less than the first angle θ₁. Accordingly, the pivot-point P₁₂ between the first segment 12a and the second segment 12b raises upwardly from the ground 102. Optionally, the first pair of wheels 28 disposed at the first segment 12a and the second pair of wheels 28 at the second segment 12b may rotate toward one another to contract the base 12 as the load deck 10 is adjusted from the lowered state 22a to the raised state 22b. Alternatively, the first pair of wheels 28 disposed at the first segment 12a and the second pair of wheels 28 disposed at the second segment 22b may rotate away from one another to expand the base 12 as the load deck 10 is adjusted from the raised state 22b to the lowered state 22a.

In the tilted state 22c, a first end portion of the tiltable deck 14 is disposed at a third height H₃ relative to the ground 102, a second end portion of the tiltable deck 14 opposite the first end portion is disposed at a fourth height H₄ relative to the ground 102 greater than the third height H₃. The first segment 12a and the second segment 12b are at a third angle θ₃ relative to one another between the first angle θ₁ and the second angle θ₂. Alternatively, the first segment 12a and the second segment 12b may be at the first angle θ₁ or the second angle θ₂ when the tiltable deck 14 is tilted. The top deck 14a may extend outwardly from the subdeck 14b to position the tiltable deck 14 closer to the ground 102 or cargo 100 in any of the states 22a-22c. The base 12, the tiltable deck 14, and the lifting mechanisms 20 may be adjusted in various combinations in addition to states 22a-22c.

The load deck 10 includes a base 12, a tiltable deck 14, and lifting mechanisms 20 disposed between the base 12 and the tiltable deck 14. The base 12 includes a first segment 12a pivotably coupled to a second segment 12b at a pivot-point P₁₂ about which the first segment 12a and the second segment 12b may rotate. The tiltable deck 14 includes a top deck 12a slidably coupled to the subdeck 14b, such that the top deck 14a may extend outwardly from the subdeck 14b. The lifting mechanisms 20 raise and lower the tiltable deck 14 in various orientations by expanding and/or contracting between the tiltable deck 14 and the base 12. A plurality of wheels 28 are rotatably coupled to the base 12 and may be driven by a propulsion system 24, such as an electrical propulsion system 24 including a battery 38 and one or more electrical motors 42. A control system 44 may receives instructions from a user 106 and perform operations of the load deck 10.

The load deck 10 may adjust the orientation of the base 12 and/or the tiltable deck 14 in order to load, unload, and transport cargo 100. The load deck 10 may adjust the height and angle of the tiltable deck 14, extend or retract the top deck 14a, and/or adjust the angle of the first segment 12a and the second segment 12b of the base 12. The load deck 10 may be oriented in various states 22 to facilitate loading, transporting, and unloading cargo 100 by adjusting the base 12 and the tiltable deck 14 with the lifting mechanisms 20 and/or the propulsion system 24. The load deck 10 may position and/or extend the tiltable deck 14 toward cargo 100, reducing the risk of damaging the cargo 100, reducing the need for external equipment, and reducing the need for human intervention that may lead to injuries when loading and/or unloading the cargo 100 from the load deck 10. The load deck 10 may reduce risk of damaging cargo 100 in transit by selectively expanding and contracting the lifting mechanisms 20 to maintain the tiltable deck 14 in a level orientation as the load deck 10 traverses uneven terrain. The load deck 10 may transition among a passive trailer operating state 26a, an active trailer operating state 26b, and a self-propelled operating state 26c to maximize energy efficiency of the load deck 10, reduce energy consumption of a tow vehicle 104, and autonomously perform movements selected by a remote user 106 of the load deck 10.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A load deck comprising:
a base including a first segment and a second segment, the first segment and the second segment pivotable relative to one another;
a tiltable deck disposed at the base;
a plurality of wheels rotatably coupled to the base and configured to support the load deck at a ground surface; and
a lifting mechanism disposed between the base and the tiltable deck, the lifting mechanism configured to adjust the load deck between at least (i) a lowered state, where the tiltable deck is disposed at a first height relative to the ground surface and the first segment and the second segment are at a first angle relative to one another, and (ii) a raised state, where the tiltable deck is disposed at a second height relative to the ground surface greater than the first height and the first segment and the second segment are at a second angle relative to one another less than the first angle.

2. The load deck of claim 1, wherein the lifting mechanism is configured to adjust the load deck to a tilted state, where a first end portion of the tiltable deck is disposed at a third height relative to the ground surface, a second end portion of the tiltable deck opposite the first end portion is disposed at a fourth height relative to the ground surface greater than the third height, and the first segment and the second segment are at a third angle relative to one another between the first angle and the second angle.

3. The load deck of claim 1, wherein the base includes a third segment, the first segment of the base pivotably coupled to the third segment of the base, and the second segment of the base pivotably coupled to the third segment of the base.

4. The load deck of claim 1, wherein the lifting mechanism includes a plurality of lifting mechanisms.

5. The load deck of claim 4, wherein a first lifting mechanism of the plurality of lifting mechanisms is coupled to the first segment of the base and a second lifting mechanism of the plurality of lifting mechanisms is coupled to the second segment of the base.

6. The load deck of claim 1, wherein the lifting mechanism is configured to expand between the tiltable deck and the base to adjust the load deck from the lowered state toward the raised state, and the lifting mechanism is configured to contract between the tiltable deck and the base to adjust the load deck from the raised state toward the lowered state.

7. The load deck of claim 1, wherein the lifting mechanism includes at least one selected from the group consisting of (i) an inflatable bladder, (ii) a hydraulic piston, and (iii) an electromechanical jack.

8. The load deck of claim 1, wherein the tiltable deck includes a top deck slidably coupled to a subdeck.

9. The load deck of claim 1, wherein the plurality of wheels includes a first pair of wheels disposed at the first segment and a second pair of wheels disposed at the second segment, the first pair of wheels and the second pair of wheels moving toward one another along the ground surface as the load deck is adjusted from the lowered state to the raised state.

10. The load deck of claim 9, wherein the first pair of wheels is slidably coupled to the first segment and the second pair of wheels is slidably coupled to the second segment.

11. A trailer comprising:
a base including a first segment and a second segment, the first segment and the second segment pivotable relative to one another;
a tiltable deck disposed at the base;
a reinforcement plate coupled to the tiltable deck, the first segment, and the second segment;
a plurality of wheels rotatably coupled to the base and configured to support the trailer at a ground surface;
a hitch connector coupled to the base and configured to connect the trailer to a vehicle; and
a lifting mechanism disposed between the base and the tiltable deck, the lifting mechanism configured to adjust the trailer between at least (i) a lowered state, where the tiltable deck is disposed at a first height relative to the ground surface and the first segment and the second segment are at a first angle relative to one another, and (ii) a raised state, where the tiltable deck is disposed at a second height relative to the ground surface greater than the first height and the first segment and the second segment are at a second angle relative to one another less than the first angle.

12. The trailer of claim 11, wherein the lifting mechanism is configured to adjust the trailer to a tilted state, where a first end portion of the tiltable deck is disposed at a third height relative to the ground surface, a second end portion of the tiltable deck opposite the first end portion is disposed at a fourth height relative to the ground surface greater than the third height, and the first segment and the second segment are at a third angle relative to one another between the first angle and the second angle.

13. The trailer of claim 11, wherein the base includes a third segment, the first segment of the base pivotably coupled to the third segment of the base, and the second segment of the base pivotably coupled to the third segment of the base.

14. The trailer of claim 11, wherein the lifting mechanism includes a plurality of lifting mechanisms.

15. The trailer of claim 14, wherein a first lifting mechanism of the plurality of lifting mechanisms is coupled to the first segment of the base and a second lifting mechanism of the plurality of lifting mechanisms is coupled to the second segment of the base.

16. The trailer of claim 11, wherein the lifting mechanism includes at least one selected from the group consisting of (i) an inflatable bladder, (ii) a hydraulic piston, and (iii) an electromechanical jack.

17. The trailer of claim 11, wherein the tiltable deck includes a top deck slidably coupled to a subdeck.

18. The trailer of claim 11, wherein the plurality of wheels includes a first pair of wheels disposed at the first segment and a second pair of wheels disposed at the second segment, the first pair of wheels and the second pair of wheels moving toward one another along the ground surface as the trailer is adjusted from the lowered state to the raised state.

19. The trailer of claim 11, further comprising a locking mechanism, the locking mechanism configured to releasably fix the tiltable deck to the base.

20. A vehicle comprising:
a base including a first segment and a second segment, the first segment and the second segment pivotable relative to one another;
a tiltable deck disposed at the base, the tiltable deck including a top deck slidably coupled to a subdeck;
a plurality of wheels rotatably coupled to the base and configured to support the vehicle at a ground surface;
a propulsion system configured to drive the plurality of wheels to move the vehicle along the ground surface;
a first lifting mechanism disposed between the first segment and the tiltable deck; and
a second lifting mechanism disposed between the second segment and the tiltable deck, the first lifting mechanism and the second lifting mechanism configured to adjust the vehicle between at least (i) a lowered state, where the tiltable deck is disposed at a first height relative to the ground surface and the first segment and the second segment are at a first angle relative to one another, (ii) a raised state, where the tiltable deck is disposed at a second height relative to the ground surface greater than the first height and the first segment and the second segment are at a second angle relative to one another less than the first angle, and (iii) a tilted state, where a first end portion of the tiltable deck is disposed at a third height relative to the ground surface, a second end portion of the tiltable deck opposite the first end portion is disposed at a fourth height relative to the ground surface greater than the third height, and the first segment and the second segment are at a third angle relative to one another between the first angle and the second angle.
